(19) United States
(12) Patent Application Publication
(10) Pub. No.: US 2020/0370575 A1
(43) Pub. Date: Nov. 26, 2020

(54) Adjustable Clamping Device for Trailer Truck

(71) Applicant: Chao-Heng Lin, Taiyuan City (TW)

(72) Inventor: Chao-Heng Lin, Taiyuan City (TW)

(21) Appl. No.: 16/419,047

(22) Filed: May 22, 2019

(51) Int. Cl. F16B 2/06; F16C 11/04; B60P 7/08

(52) U.S. Cl. CPC F16B 2/065; B60P 7/0807; F16C 11/04

(57) ABSTRACT

An adjustable clamping device includes a connecting member mounted on a crossbar of a trailer truck, a positioning member mounted on a top face of the connecting member, a rotation member mounted on a bottom face of the connecting member and provided with a threaded rod extending into the connecting member, and a pressing member mounted on the threaded rod and received in the connecting member. The bottom face of the connecting member is provided with a screw hole. The threaded rod of the rotation member is screwed through the screw hole into the connecting member. Thus, the pressing member is moved upward or downward by revolving the rotation member to adjust the distance between the top face of the connecting member and the pressing member.

### BACKGROUND OF THE INVENTION

### 1. Field of the Invention

The present invention relates to a trailer truck (or tow truck) and, more particularly, to a clamping device for a trailer truck.

### 2. Description of the Related Art

A conventional trailer truck 10 in accordance with the prior art shown in FIG. 1 comprises two bottom rails 103, two recessed holders (or stake pockets) 104 respectively mounted on the two bottom rails 103 by soldering, and two fixtures (or lashing winches) 101 respectively mounted on the two recessed holders 104 by insertion. Each of the two fixtures 101 includes a pressing member 1011. In practice, a cargo 102 is placed on the trailer truck 10 and is tied by a cable 105. The cable 105 has two ends attached to the two fixtures 101 respectively. Each of the two ends of the cable 105 is pressed and tightened by the pressing member 1011 of each of the two fixtures 101, such that the cargo 102 is positioned in place by the cable 105. However, the two recessed holders 104 are soldered on the two bottom rails 103, such that the position of each of the two fixtures 101 is fixed and cannot be adjusted according to the practical requirement (such as size or location) of the cargo 102, thereby causing inconvenience to the user in binding the cargo 102.

### BRIEF SUMMARY OF THE INVENTION

The primary objective of the present invention is to provide an adjustable clamping device that is used to clamp crossbars of different thickness.

In accordance with the present invention, there is provided a clamping device comprising a connecting member mounted on a crossbar of a trailer truck, a positioning member mounted on a top face of the connecting member, a rotation member mounted on a bottom face of the connecting member and provided with a threaded rod extending into the connecting member, and a pressing member mounted on the rotation member and received in the connecting member. The top face of the connecting member is provided with a threaded post. The bottom face of the connecting member is provided with a screw hole. The positioning member is screwed onto the threaded post of the connecting member. The threaded rod of the rotation member is screwed through the screw hole of the connecting member into the connecting member. The pressing member is mounted on the threaded rod of the rotation member. A receiving space is defined between the top face of the connecting member and the pressing member.

Preferably, the positioning member is swiveled relative to the connecting member through 360 degrees.

Preferably, the positioning member has a type that is changed such that the positioning member is available for trailer trucks of different types.

Preferably, the retaining member has a D-shaped configuration.

Preferably, the threaded rod of the rotation member has a top provided with a resting ball, and the pressing member is secured on the resting ball of the rotation member. The pressing member has a bottom provided with a mounting ring mounted on the resting ball of the rotation member such that the pressing member is connected with the rotation member.

Preferably, when the crossbar of the trailer truck is unlocked from the clamping device, the clamping device is movable on the crossbar of the trailer truck.

Preferably, a retaining member is pivotally mounted on the positioning member.

Preferably, the pressing member is moved by rotation of the rotation member to adjust a distance between the top face of the connecting member and the pressing member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional trailer truck in accordance with the prior art.

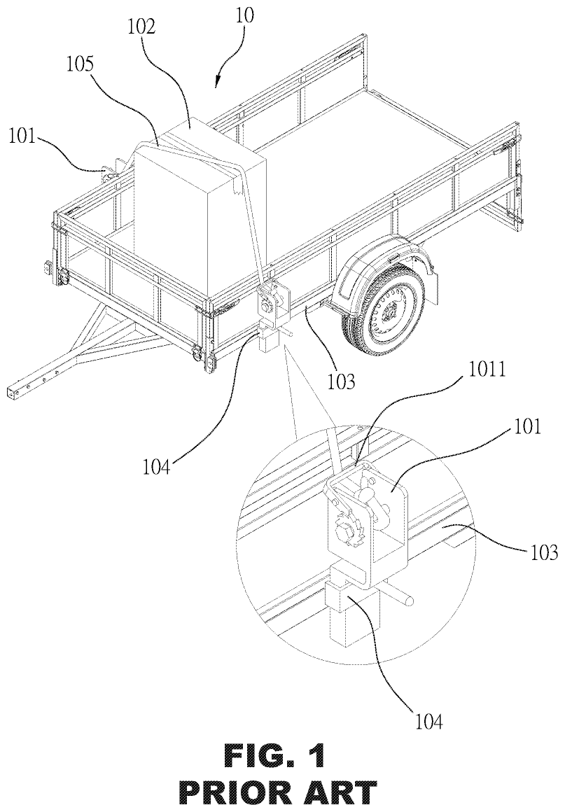

FIG. 2 is a perspective view of a clamping device in accordance with the preferred embodiment of the present invention.

FIG. 3 is an exploded perspective view of the clamping device in accordance with the preferred embodiment of the present invention.

FIG. 4 is a perspective operational view of the clamping device in accordance with the preferred embodiment of the present invention.

FIG. 5 is a side operational view of the clamping device in accordance with the preferred embodiment of the present invention.

FIG. 6 is a perspective view of the clamping device for a trailer truck in accordance with the preferred embodiment of the present invention.

FIG. 7 is a side operational view of the clamping device for a trailer truck in accordance with the preferred embodiment of the present invention.

FIG. 8 is a side operational view of the clamping device for a trailer truck in accordance with another preferred embodiment of the present invention.

FIG. 9 is a perspective operational view of the clamping device for a trailer truck in accordance with another preferred embodiment of the present invention.

FIG. 10 is a perspective operational view of a clamping device in accordance with another preferred embodiment of the present invention.

FIG. 11 is a perspective view of the clamping device for a trailer truck in accordance with another preferred embodiment of the present invention.

### DETAILED DESCRIPTION OF THE INVENTION

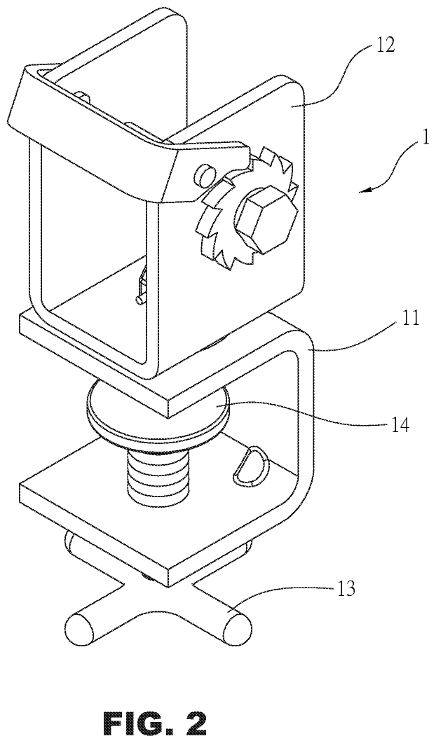

Referring to the drawings and initially to FIGS. 2-7, an adjustable clamping device 1 in accordance with the preferred embodiment of the present invention comprises a connecting member (or bracket or piece or block) 11 mounted on a crossbar (or transverse rod or rail) 21 of a trailer truck 2, a positioning member (or bracket or piece or block or lashing winch) 12 mounted on a top face of the connecting member 11 by screwing, a rotation member (or knob) 13 mounted on a bottom face of the connecting member 11 and provided with a threaded rod 131 extending into the connecting member 11, and a pressing (or resting or clamping) member (or piece or plate or board) 14 mounted on the threaded rod 131 of the rotation member 13 and received in the connecting member 11.

The top face of the connecting member 11 is provided with a threaded post (or pillar or column or stud) 111. The bottom face of the connecting member 11 is provided with a screw hole 112. The positioning member 12 is screwed onto the threaded post 111 of the connecting member 11. Preferably, the positioning member 12 is provided with a threaded portion screwed onto the threaded post 111 of the connecting member 11. A retaining (or fastening) member (or snap ring) 121 is pivotally mounted on the positioning member 12. The threaded rod 131 of the rotation member 13 is screwed through the screw hole 112 of the connecting member 11 into the connecting member 11. Preferably, the threaded rod 131 of the rotation member 13 has a top provided with a resting ball 132. The pressing member 14 is secured on the resting ball 132 of the rotation member 13. Preferably, the pressing member 14 has a bottom provided with a mounting (or retaining) ring 141 mounted on the resting ball 132 of the rotation member 13 such that the pressing member 14 is connected with the rotation member 13. A receiving space is defined between the top face of the connecting member 11 and the pressing member 14.

In assembly, the positioning member 12 is screwed onto the threaded post 111 of the connecting member 11. Then, the threaded rod 131 of the rotation member 13 is screwed through the screw hole 112 of the connecting member 11 into the connecting member 11. Then, the mounting ring 141 of the pressing member 14 is secured on the resting ball 132 of the rotation member 13, such that the pressing member 14 is mounted on the rotation member 13. At this time, the receiving space is defined between the top face of the connecting member 11 and the pressing member 14. Thus, the connecting member 11, the positioning member 12, the rotation member 13, and the pressing member 14 are assembled to construct the clamping device 1.

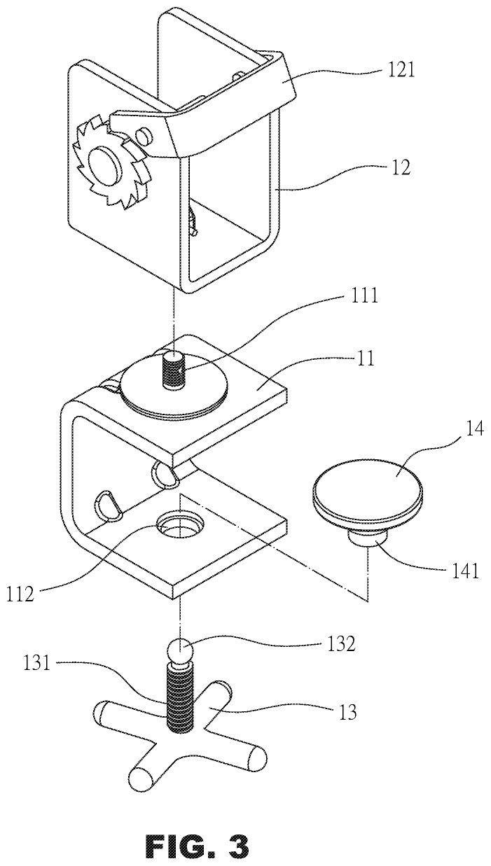

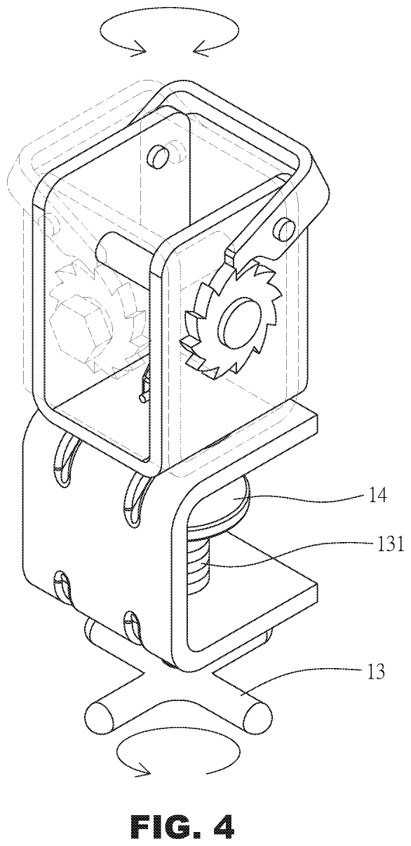

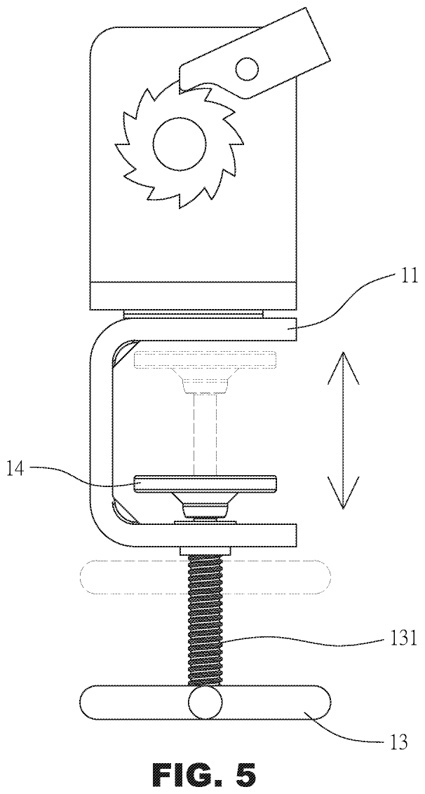

In operation, referring to FIGS. 4 and 5 with reference to FIGS. 2 and 3, when the rotation member 13 is rotated, the threaded rod 131 of the rotation member 13 is rotated in the screw hole 112 of the connecting member 11, and moved upward or downward relative the connecting member 11, such that the pressing member 14 is moved upward or downward relative to the connecting member 11 as shown in FIG. 5. Thus, the pressing member 14 is moved upward or downward in the connecting member 11 by rotation of the rotation member 13 to adjust the receiving space or the distance between the top face of the connecting member 11 and the pressing member 14. In addition, the positioning member 12 is swiveled relative to the connecting member 11 through three hundred and sixty degrees (360°), to adjust the angle of the positioning member 12 as shown in FIG. 4.

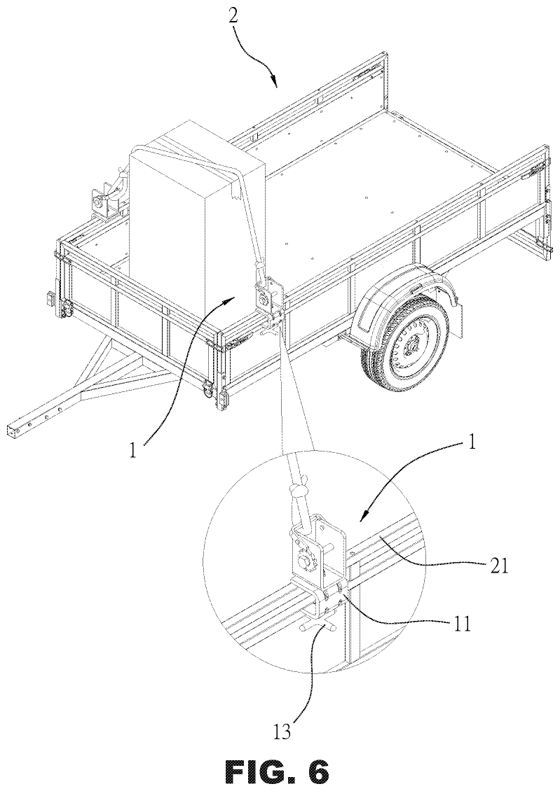

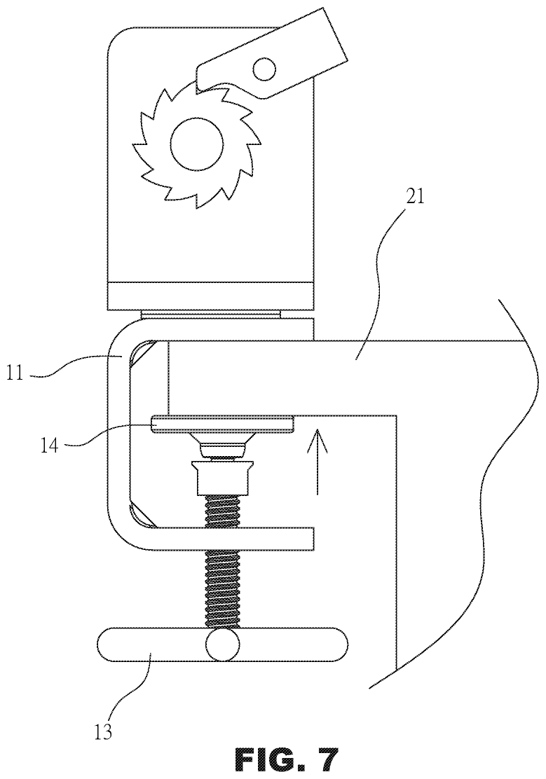

In practice, referring to FIGS. 6 and 7 with reference to FIGS. 2-5, the connecting member 11 of the clamping device 1 is mounted on the crossbar 21 of the trailer truck 2. Then, when the rotation member 13 is rotated, the pressing member 14 is moved upward to press the crossbar 21 of the trailer truck 2, such that the crossbar 21 of the trailer truck 2 is clamped between the pressing member 14 and the connecting member 11 as shown in FIG. 7. Thus, the clamping device 1 is locked onto the crossbar 21 of the trailer truck 2 as shown in FIG. 6. In such a manner, the distance between the top face of the connecting member 11 and the pressing member 14 to fit the crossbar 21 of different thickness. In addition, when the crossbar 21 of the trailer truck 2 is unlocked from the clamping device 1, the clamping device 1 is movable on the crossbar 21 of the trailer truck 2.

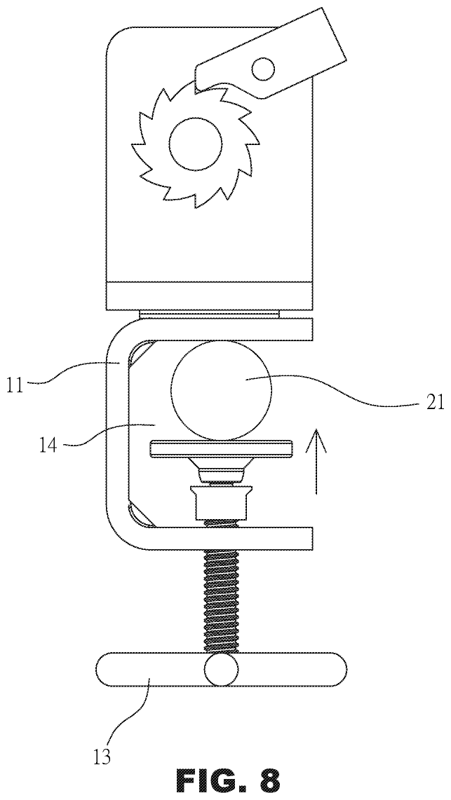

As shown in FIG. 8, the connecting member 11 and the pressing member 14 of the clamping device 1 are used to clamp the crossbar 21 that has a circular shape. Thus, the clamping device 1 is available for the crossbar 21 of the trailer truck 2 of different shapes, types and specifications, and is available for trailer trucks of different types.

Accordingly, the clamping device 1 is locked or unlocked by operating the rotation member 13, such that the clamping device 1 is locked onto or unlocked from the crossbar 21 of the trailer truck 2 easily and conveniently, thereby facilitating the user operating the clamping device 1. In addition, when the clamping device 1 is unlocked, the clamping device 1 is moved on the crossbar 21 of the trailer truck 2 to change the location of the clamping device 1. Further, the positioning member 12 is swiveled relative to the connecting member 11 through 360 degrees, such that the positioning member 12 of the clamping device 1 is angle adjusted.

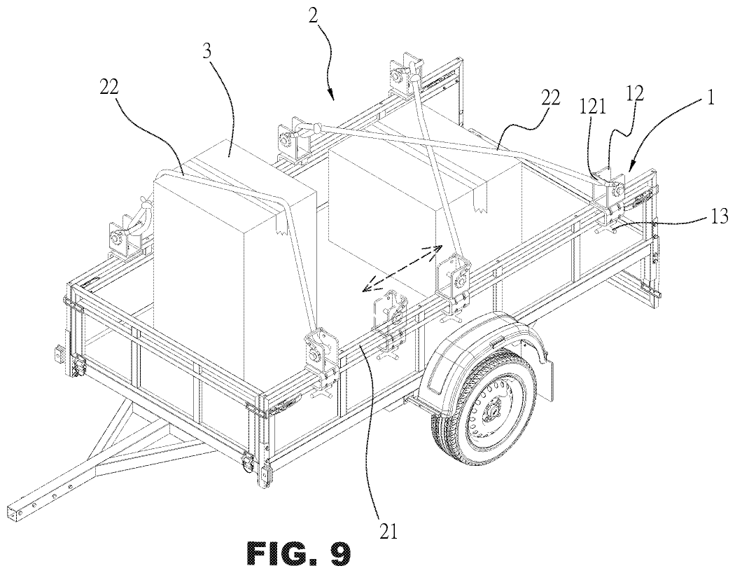

Referring to FIG. 9 with reference to FIGS. 2-7, cargos 3 are placed on the trailer truck 2 and bound or tied by multiple ropes 22 which are fastened by multiple clamping devices 1. The retaining member 121 of each of the clamping devices 1 presses each of the ropes 22, such that the ropes 22 are tightened by the clamping devices 1. In such a manner, the positioning member 12 is swiveled relative to the connecting member 11 through 360 degrees, such that the positioning member 12 of each of the clamping devices 1 is angle adjusted to fit the orientation of each of the ropes 22. Thus, the cargos 3 are bound by the ropes 22 tightly and closely. In addition, when each of the clamping devices 1 is unlocked, each of the clamping devices 1 is moved on the crossbar 21 of the trailer truck 2, to change the location of each of the clamping devices 1, thereby facilitating the user locating and binding the cargos 3. Thus, the location of each of the clamping devices 1 is adjusted according to the size of each of the cargos 3.

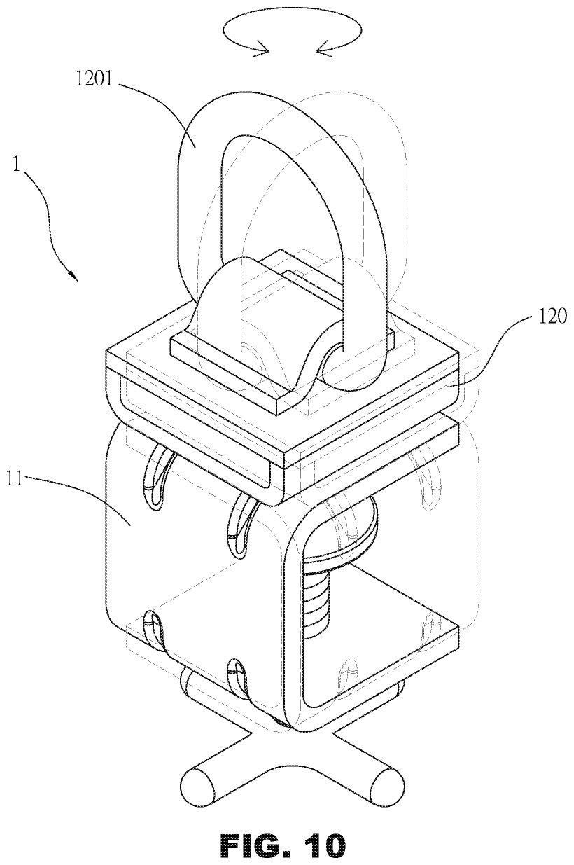

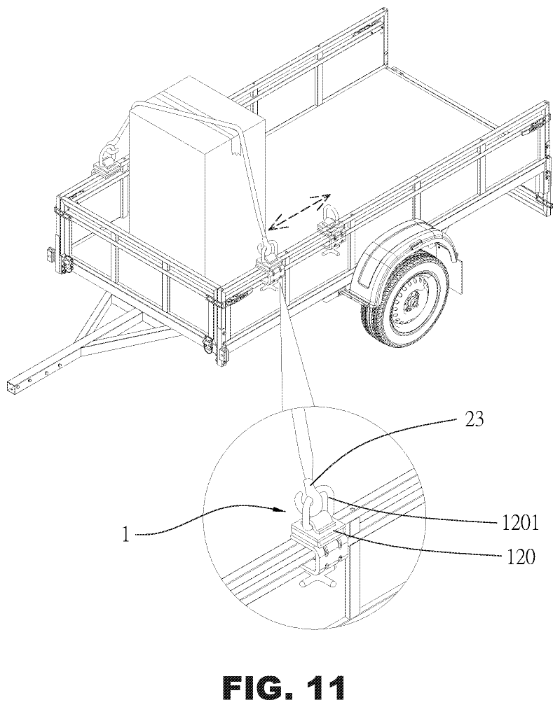

Referring to FIGS. 10 and 11, a movable D-shaped retaining member (or snap ring) 1201 is pivotally mounted on the positioning member 120. In practice, a hook 23 of the trailer truck 2 is hooked onto the D-shaped retaining member 1201 of the clamping device 1. Thus, the type of the positioning member is changed such that the positioning member is available for trailer trucks of different types.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A clamping device comprising:
a connecting member mounted on a crossbar of a trailer truck;
a positioning member mounted on a top face of the connecting member;
a rotation member mounted on a bottom face of the connecting member and provided with a threaded rod extending into the connecting member; and
a pressing member mounted on the rotation member and received in the connecting member;
wherein:
the top face of the connecting member is provided with a threaded post;
the bottom face of the connecting member is provided with a screw hole;
the positioning member is screwed onto the threaded post of the connecting member;
the threaded rod of the rotation member is screwed through the screw hole of the connecting member into the connecting member;
the pressing member is mounted on the threaded rod of the rotation member; and
a receiving space is defined between the top face of the connecting member and the pressing member.

2. The clamping device of claim 1, wherein the positioning member is swiveled relative to the connecting member through 360 degrees.

3. The clamping device of claim 1, wherein the positioning member has a type that is changed such that the positioning member is available for trailer trucks of different types.

4. The clamping device of claim 1, wherein the retaining member has a D-shaped configuration.

5. The clamping device of claim 1, wherein the threaded rod of the rotation member has a top provided with a resting ball, the pressing member is secured on the resting ball of the rotation member, and the pressing member has a bottom provided with a mounting ring mounted on the resting ball of the rotation member such that the pressing member is connected with the rotation member.

6. The clamping device of claim 1, wherein when the crossbar of the trailer truck is unlocked from the clamping device, the clamping device is movable on the crossbar of the trailer truck.

7. The clamping device of claim 1, wherein a retaining member is pivotally mounted on the positioning member.

8. The clamping device of claim 1, wherein the pressing member is moved by rotation of the rotation member to adjust a distance between the top face of the connecting member and the pressing member.
